(19) United States
(12) Patent Application Publication
(10) Pub. No.: US 2025/0178070 A1
(43) Pub. Date: Jun. 5, 2025

(54) CUTTING HEAD FOR POCKET SHEAR

(71) Applicant: Felix Sorkin, Stafford, TX (US)

(72) Inventor: Felix Sorkin, Stafford, TX (US)

(21) Appl. No.: 19/048,878

(22) Filed: Feb. 8, 2025

Related U.S. Application Data
(63) Continuation-in-part of application No. 18/807,358, filed on Aug. 16, 2024.
Application No. 18/807,358 is a division of application No. 17/135,318, filed on Dec. 28, 2020, now Pat. No. 12,134,119.
(60) Provisional application No. 63/551,128, filed on Feb. 8, 2024.
(60) Provisional application No. 62/968,789, filed on Jan. 31, 2020.
(60) Provisional application No. 63/006,202, filed on Apr. 7, 2020.

(51) Int. Cl. B21F 11/00; B23D 29/00; B23D 29/02

(52) U.S. Cl. CPC B21F 11/00; B23D 29/002; B23D 29/023

(57) ABSTRACT

The present application pertains to an embodiment of a cutting assembly in a handheld strand cutter for use with stressing concrete, and a method of using the cutting assembly. The cutting assembly includes a nose piece body configured to couple with a strand cutter device and having a fixed blade receptacle to receive a fixed blade having angular sides, a drive gear having a rotating blade receptacle to receive a rotating blade assembly that has a cutting body, a shoulder, a replaceable shear blade or a cutting edge, and a drive gear engagement portion having a hexagonal shape.

### CROSS-REFERENCE TO RELATED APPLICATIONS

This application is a continuation-in-part application of and which claims priority to U.S. patent application Ser. No. 18/807,358, filed Aug. 16, 2024, which is a divisional of U.S. patent application Ser. No. 17/135,318, filed on Dec. 28, 2020, which claims priority from U.S. provisional application No. 62/968,789, filed Jan. 31, 2020 and U.S. provisional application No. 63/006,202, filed Apr. 7, 2020, each of which is incorporated by reference herein in its entirety.

This application also claims priority to U.S. Provisional Patent Application No. 63/551,128, entitled “Cutting Head for Pocket Shear,” filed on Feb. 8, 2024. The entire disclosure of this priority application is incorporated herein by reference in its entirety.

### TECHNICAL FIELD/FIELD OF THE DISCLOSURE

The present disclosure is directed to a device for shearing a cable and more specifically, a cutting head for a tool to shear tensioning tendons.

### BACKGROUND OF THE DISCLOSURE

Many structures are built using concrete, including, for instance, buildings, parking structures, apartments, condominiums, hotels, mixed-use buildings, casinos, hospitals, medical buildings, government buildings, research/academic institutions, industrial buildings, malls, bridges, pavement, tanks, reservoirs, silos, foundations, sports courts, and other structures.

Pre-stressed concrete is structural concrete in which internal stresses are introduced to reduce potential tensile stresses in the concrete resulting from applied loads. This can be accomplished by two methods-pre-tensioned pre-stressing and post-tensioned pre-stressing. When post-tensioning concrete, the pre-stressing assembly is tensioned after the concrete has cured to a specified strength. The pre-stressing assembly, commonly known as a tendon, may include for example and without limitation, anchorages, one or more strands, and sheaths or ducts surrounding the strand(s). A strand may be tensioned between a pair of anchors, which are embedded in the concrete. The strand may be formed from a metal or composite or any suitable material exhibiting tensile strength, including, for example and without limitation, reinforcing steel, single wire cable, or multi-wire cable. The strand is typically fixedly coupled to a fixed anchorage positioned at one end of the tendon, the so-called “fixed end”, and is adapted to be stressed at the other anchor, the “stressing end” of the tendon. The strand is generally retained in each anchor by one or more wedges that engage a tapered recess in the anchor body so that when the strand is placed under tension, the wedges engage the strand more tightly.

One end of the strand extends through the stressing end anchor and out of the concrete body in which the anchor is embedded. In some cases, a pocket former is placed around the strand before the concrete is poured, which results in a pocket in the cured concrete. In these cases, the end of the strand extends through and outwardly from the pocket. Once the concrete has cured, a tensile force can be applied to the extending strand end, causing an elongation of the strand. Releasing the tensile force causes the strand to be more tightly gripped by the wedges, thereby maintaining its elongated stress, which is transferred to the concrete via the anchors. The portion of the strand that extends out of the stressing anchor is typically removed.

After the concrete member is stressed, the tension member extends beyond the edge of the concrete segment. The portion of the tension member that extends beyond the edge of the concrete member is removed by cutting. Methods of cutting include an abrasive saw or an arm with a sharp edge that cuts the cable, and a conventional acetylene torch or cutting torch. However, use of the open flame of a torch creates some danger of fire or explosion in the surrounding environment. Also, cutting the metal cable with a torch at a point near to the tensioning wedges causes the cable and wedges to become heated and may result in a loss of temper of the metal or loosening of the post-tensioning wedges. Further, using torches to cut tendons often requires operators to obtain hot work permits, which can be costly and time consuming.

These and other deficiencies exist.

### SUMMARY

Exemplary embodiments include a cutting assembly for a strand cutter including a nose piece body configured to couple with a strand cutter device and having a fixed blade receptacle; a fixed blade having angular sides that is configured to be received in the fixed blade receptacle; a drive gear having a rotating blade receptacle; a rotating blade assembly, wherein the rotating blade assembly includes a cutting body, a shoulder, a replaceable shear blade or a cutting edge, and a drive gear engagement portion having an angular shape; and the rotating blade assembly being configured to be received in the rotating blade receptacle and the drive gear is configured to engage a drive assembly so as to allow transmission of torque from the drive assembly through the drive gear to the rotating blade assembly.

Another exemplary embodiment includes a rotating blade assembly for a strand cutter, including a rotating shear blade assembly that comprises a drive gear engagement having an angular shape and a strand channel, wherein the drive gear engagement is configured to engage a drive assembly.

Another exemplary embodiment includes a fixed blade assembly for a strand cutter, including a strand channel; and a outer surface having an angular shape configured to non-rotabably engage a mounting recess inside of a nose piece assembly.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is an isometric view of a strand cutter in accordance with an embodiment of the disclosure.

FIG. 2 is an isometric exploded view of the strand cutter of FIG. 1.

FIG. 3 is an end view of the strand cutter of FIG. 1.

FIG. 4 is a cross-section along lines 4-4 of FIG. 3.

FIG. 5 is an enlarged view of a portion of FIG. 4.

FIG. 6 is an isometric exploded view of a clamp assembly in accordance with an embodiment of the disclosure.

FIG. 7 is an isometric view of a portion of an assembled clamp assembly in accordance with an embodiment of the disclosure.

FIG. 8 is an isometric view of a rotating blade assembly in accordance with an embodiment of the disclosure.

FIG. 9 is a side view of the rotating blade assembly of FIG. 8.

FIG. 10 is a cross-section along lines 10-10 of FIG. 9.

FIG. 11 is an enlarged view of a replaceable shear blade in accordance with an embodiment of the disclosure.

FIG. 12 is an enlarged view of a replaceable shear blade in accordance with an embodiment of the disclosure.

FIGS. 13 and 14 are isometric front and rear views, respectively, of a nose piece in accordance with an embodiment of the disclosure.

FIG. 15 is an isometric view of a flange plate for use with the embodiment of FIGS. 13 and 14.

FIG. 16 is a cross-sectional side view of the nose piece of FIG. 13.

FIGS. 17 and 18 are side and isometric views of a rotating blade assembly for use with an alternate embodiment of the disclosure.

FIGS. 19 and 20 show a perspective view and rear view of strand cutter nose piece according to an embodiment of the present disclosure.

FIGS. 21 and 22 shows front and review views of a strand cutter blade secondary drive gear according to an embodiment of the present disclosure.

FIGS. 23 and 24 show perspective views of a strand cutter rotating blade according to an embodiment of the present disclosure.

FIGS. 25 and 26 show a perspective view and front view a strand cutter fixed blade according to an embodiment of the present disclosure.

FIGS. 27a and 27b show a comparison between nose pieces according to embodiments of the present disclosure.

FIGS. 28a and 28b show a comparison between secondary drive gears according to embodiments of the present disclosure.

FIGS. 29a and 29b show a comparison between rotating blade assemblies according to embodiments of the present disclosure.

FIGS. 30a and 30b show a comparison between fixed blades according to embodiments of the present disclosure.

These and other objects, features and advantages of the exemplary embodiments of the present disclosure will become apparent upon reading the following detailed description of the exemplary embodiments of the present disclosure, when taken in conjunction with the appended paragraphs.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure provides a strand cutter for shearing post-tensioning cables, for example, in the field. Thus, the strand cutter is designed to operate adjacent to a post-tensioning anchor or within a pocket formed adjacent to a post-tensioning anchor. The strand is cut by receiving the strand eccentrically in a rotating blade assembly and rotating a replaceable shear blade relative to a fixed blade.

The present disclosure also includes an improved cutting head that provides additional torque and better wear characteristics, and may include additional other benefits.

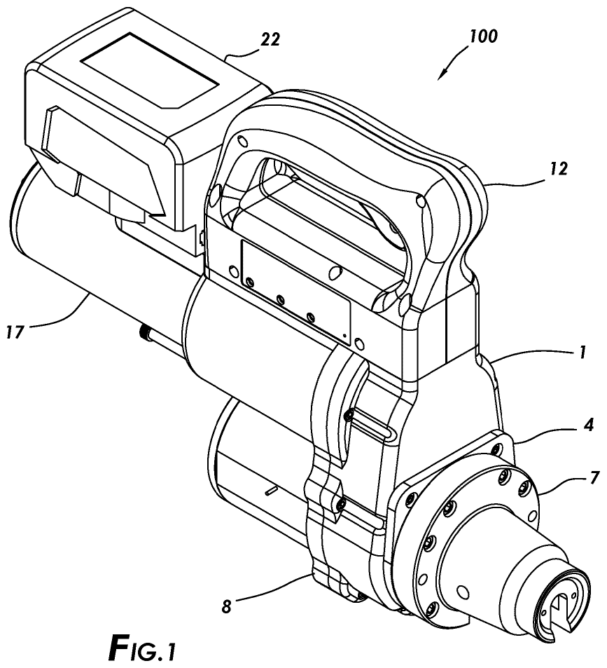

Referring to FIGS. 1 and 2, strand cutter 100 in accordance with the disclosure may include main drive housing 17. The top side of main drive housing 17 may support battery 22 and tool handle 12. Tool handle 12 may include trigger 27 and printed circuit board 16. Printed circuit board 16 may control the operation of strand cutter 100 in response to inputs that may include signals from trigger 27. Drive assembly 58, i.e., electric motor 50 and gear box 14 may be positioned within main drive housing 17. Electric motor 50 and gearbox 14 may be mechanically coupled and coaxial within main drive housing 17.

Strand cutter 100 may further include front housing 1 that is mechanically coupled to main drive housing 17. Front housing 1 may be affixed to gearbox 14 via mounting plate 8. Wear plate 4 may be mounted to the front of front housing 1 on a first side of wear plate 4. The second side of wear plate 4 may be mounted to nose piece 7. Nose piece 7, further described below, may define a cutting chamber. Front housing 1 may house primary drive gear 9 and secondary drive gear 3.

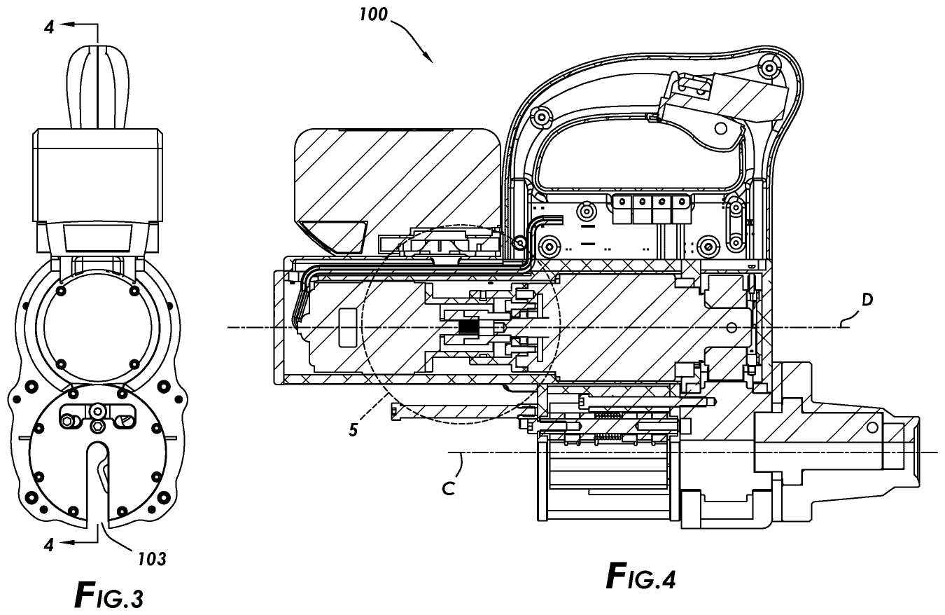

Referring to FIGS. 4 and 5, drive assembly 58 for strand cutter 100 may be housed in main drive housing 17 and may include electric motor 50, gearbox 14, and gearbox connector assembly 11 that couples electric motor 50 to gearbox 14. Gearbox connector assembly 11 may include motor mount adaptor 51, motor shaft coupler 52, gearbox shaft coupler 26, gearbox to motor mount 18, and bearing 19.

Referring again to FIG. 2, male gearbox spline 56 and coaxial output shaft 55 may extend from gearbox 14. Male gearbox spline 56 may engage female gearbox spline 15. Female gearbox spline 15 may have a hexagonal or other non-round perimeter so as to engage a corresponding receptacle in mounting plate 8. Engagement of male and female gearbox splines 56, 15, and engagement of female gearbox spline 15 with mounting plate 8 may prevent drive assembly 58 from rotating relative to other components of strand cutter 100.

Drive gears 13, including primary drive gear 9 and secondary drive gear 3, transmit torque from electric motor 50 through gear box 14 to rotating blade assembly 5 (or 105). In certain embodiments, primary drive gear 9 may include drive opening 57 that corresponds to the shape of coaxial output shaft 55, allowing the transmission of torque from coaxial output shaft 55 to primary drive gear 9. Teeth on the perimeter of primary drive gear 9 engage corresponding teeth on the outside of secondary drive gear 3, allowing the transmission of torque from primary drive gear 9 to secondary drive gear 3. Rotating blade assembly 5 (or 105) is mechanically coupled to secondary drive gear 3 so as to be rotated thereby. Rotating blade assembly 5 may extend through openings in front housing 1, wear plate 4, and into the cutting chamber in nose piece 7. Fixed blade 23 is also received and non-rotatably retained in the cutting chamber of nose piece 7 adjacent to rotating blade assembly 5. Fixed blade 23 includes fixed strand slot 77.

Electric motor 50, motor shaft coupler 52, gearbox shaft coupler 26, gearbox to motor mount 18, gearbox 14, gearbox splines 56, 15, and primary drive gear 9 define drive axis D. Similarly, clamp housing 28, secondary drive gear 3, rotating blade assembly 5 and fixed blade 23 define cutting axis C.

### Cutting Assembly

Referring now to FIGS. 8-10, strand cutter 100 may include rotating blade assembly 5. Rotating blade assembly 5 may include mounting shoulder 94, drive gear engagement 96 mounted to mounting shoulder 94, and blade mount 97 mounted to mounting shoulder 94. Mounting shoulder 94 may be configured to rotate within front housing 1 and to support rotating blade assembly 5 within the strand cutter. Drive gear engagement 96 may be non-circular and may be configured to engage a corresponding opening in secondary drive gear 3, so as to allow the transmission of torque from secondary drive gear 3 to rotating blade assembly 5. Blade mount 97 may be generally cylindrical and may comprise an outer wall 98 and an inner shaft 99. Inner shaft 99 may include blade receptacle 101, pin opening 102, and strand slot portion 104. Blade receptacle 101 may receive replaceable shear blade 110. Pin opening 102 may receive a set screw or other fastener to retain replaceable shear blade 110 within blade receptacle 101. Strand slot portion 104 may align with throat 103.

Referring now to FIG. 11, replaceable shear blade 110 in accordance with some embodiments may include first drive face 112, second drive face 113, curved outer surface 116, and blade edge 114. Second drive face 113 and curved outer surface 116 may include chamfered edge 111. Drive faces 112, 113 engage corresponding surfaces in blade receptacle 101. Drive faces 112, 113 transmit torque from inner shaft 99 to replaceable shear blade 110. Inner shaft 99 may transmit a cutting torque to first drive face 112 (clockwise as shown in FIG. 11) during a cutting operation and may transmit an opening torque (counter-clockwise in FIG. 11) to second drive face 113 after a cut has been completed. In the illustrated embodiment, drive faces 112, 113 are planar and parallel, but drive faces 112, 113 may have any suitable configuration.

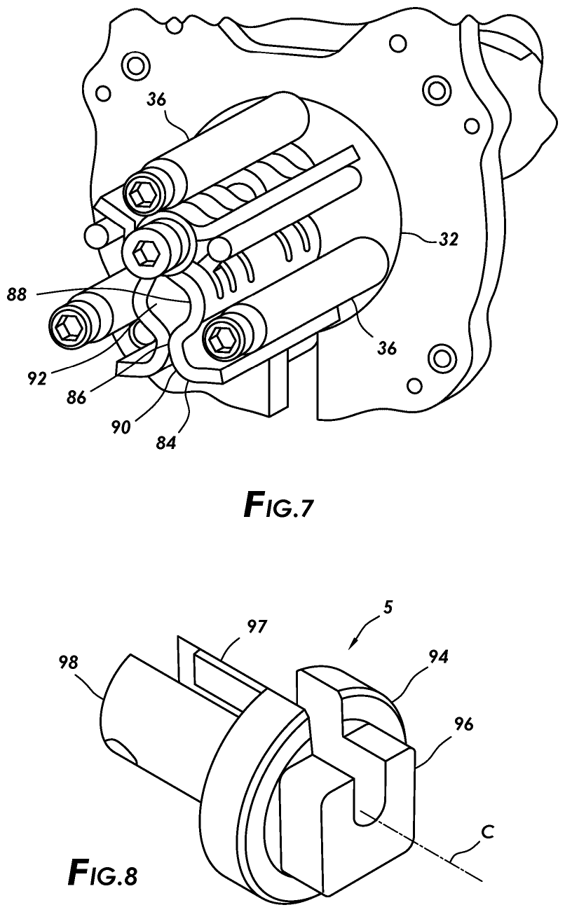

By way of example and without limitation, in some embodiments, replaceable shear blade 110 may have drive faces 115, 117, that are not parallel to cutting strand slot 120 and instead define an angle between 5 and 65 degrees with cutting strand slot 120, as shown in FIG. 12. In still other embodiments, replaceable shear blade 110 may have one drive face 115 or 117 instead of two. In some embodiments drive face 115 or 117 may extend between the bottom of cutting strand slot 120 and the outer circumference of inner shaft 99, as shown in FIGS. 11 and 12. In other embodiments drive face 115 or 117 may not extend to the outer circumference of inner shaft 99 or may not be a straight line.

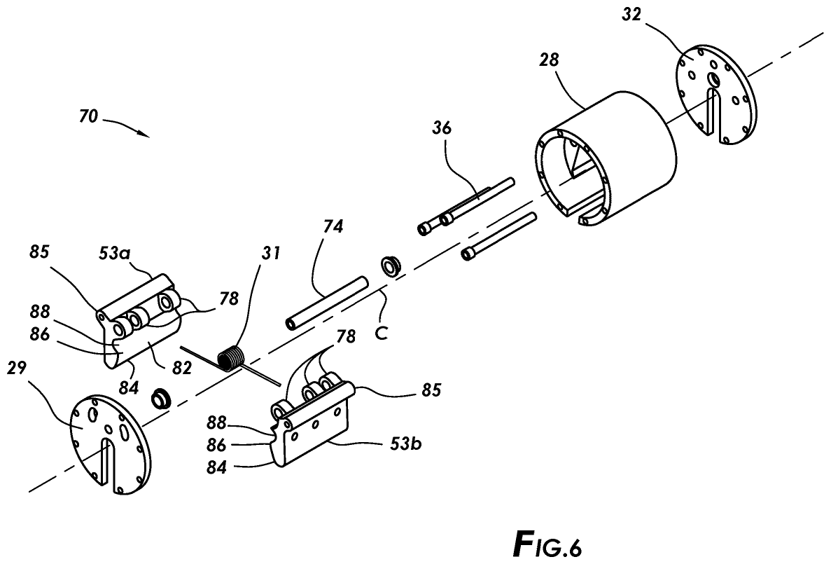

Curved outer surface 116 may match the outer surface of outer wall 98 so as to provide a substantially continuous surface. To assemble rotating blade assembly 5, replaceable shear blade 110 may be positioned in blade receptacle 101 and secured with a fastener in pin opening 102. Blade edge 114 cooperates with strand slot portion 104 of inner shaft 99 to define a cutting strand slot 120 (FIG. 10) that is aligned with strand channel 92 and fixed strand slot 77 and may receive a strand for cutting.

Because replaceable shear blade 110 is removable from rotating blade assembly 5, replaceable shear blade 110 may be replaced when worn or damaged. Likewise, replaceable shear blade 110 may be selected from a variety of replaceable shear blades 110 of different materials or hardnesses, depending on the cutting application. In some embodiments, replaceable shear blade 110 may be accessed by removing nose piece 7 and removing the pin in pin opening 102.

U-shaped strand slots 120, 77 of rotating blade assembly 5 and fixed blade 23, respectively, are configured to receive a strand (cable) therein. The “bottom” or terminus of each U-shaped strand slot may be adjacent to cutting axis C. Fixed blade 23 and rotating blade assembly 5 are configured such that a strand positioned in the respective strand slots will be sheared when rotating blade assembly 5 has rotated 180° about cutting axis C. When cutting strand slot 120 of rotating blade assembly 5 is aligned with fixed strand slot 77 of fixed blade 23, i.e. at 0° of rotation, the tool is in a fully open position.

### Alternate Embodiment of Cutting Assembly

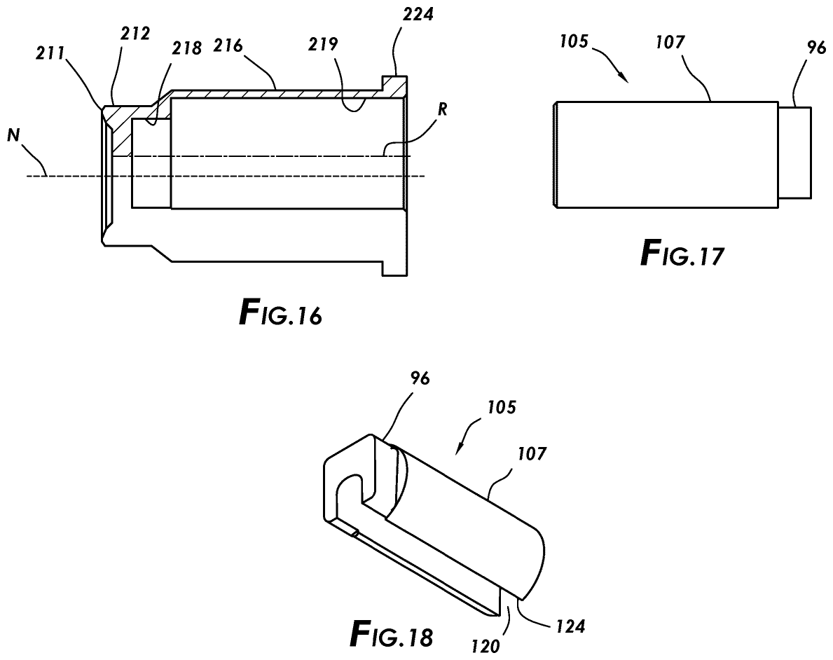

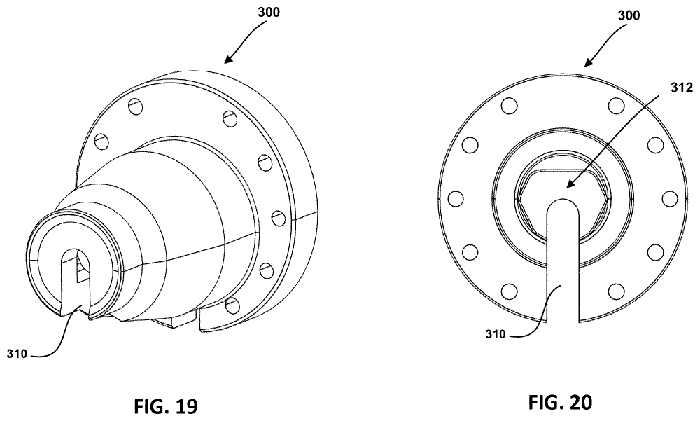

As described above, for example, strand cutter 100 may use the described cutting assembly embodiment. The strand cutter 100 may use an alternate, or second, embodiment of the cutting assembly. Accordingly, the strand cutter 100 may use either cutting assembly configuration and the disclosure of the present specification is applicable to either the above disclosed cutting assembly or the alternate cutting assembly described in this section with respect to FIGS. 19-26. That is, the alternate cutting assembly of FIGS. 19-26 may be used in place of (i.e., substituted for) the cutting assembly disclosure of FIGS. 2, 9-12, and 13-16, as well as other disclosure herein describing the use of the cutting assembly.

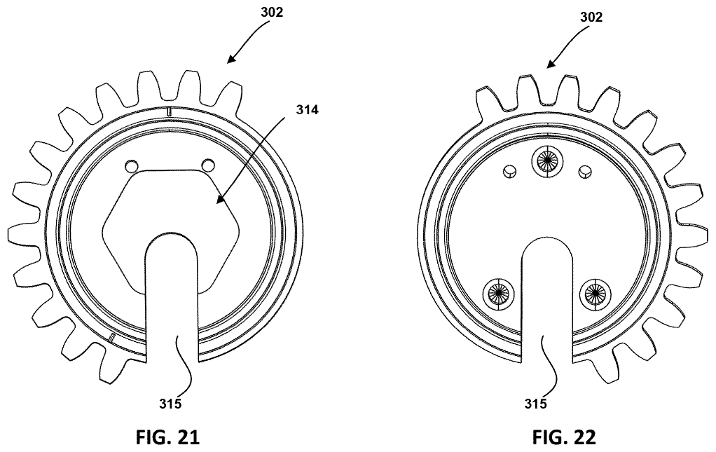

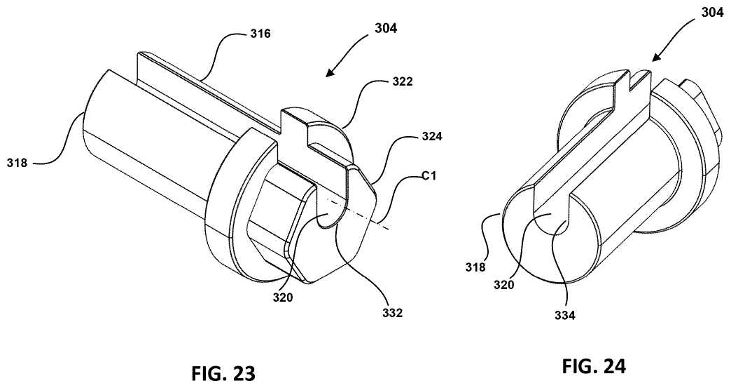

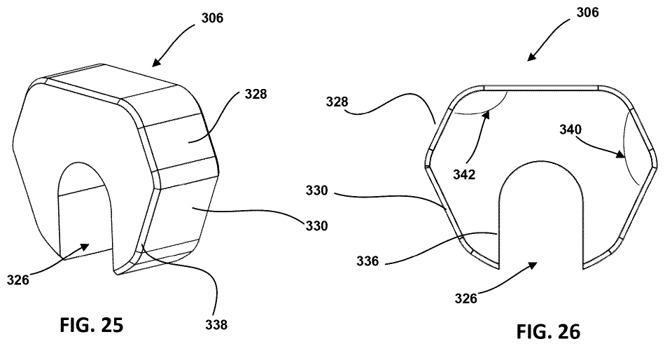

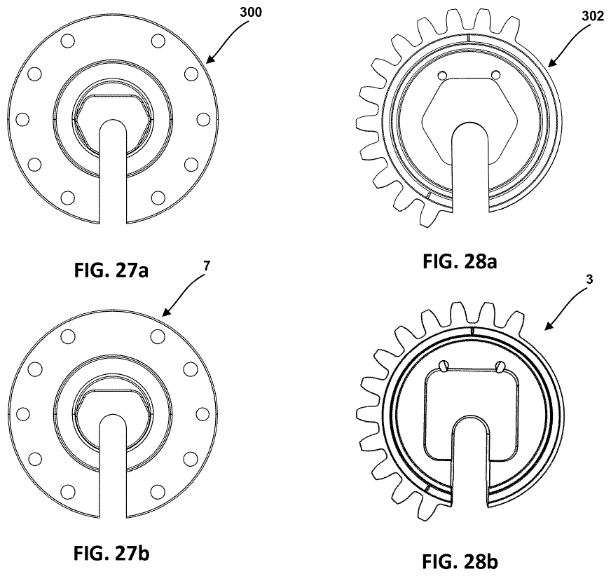

It should also be appreciated that this cutting assembly may be used with other strand or tendon cutters. This cutting assembly configuration is shown in FIGS. 19-26. FIGS. 19 and 20 show a nose piece 300, FIGS. 21 and 22 show a secondary drive gear 302, FIGS. 23 and 24 show a rotating blade assembly 304, and FIGS. 25 and 26 show a fixed blade 306 that correspond to this embodiment of a cutting assembly. A comparison of these Figures, with FIGS. 8-10, for example, highlights the differences of this design. FIGS. 27-30 provide a comparison between the different embodiments. A more detailed description of the alternate cutting assembly follows.

This alternate design may result in greater torque transmission from the drive gear through the rotating blade and as acted upon the fixed blade through a tendon to be cut. The exemplary designs of embodiments of the present disclosure may result in greater capacity for a pocket shear as well as increased durability and longevity.

Referring to FIGS. 19 and 20, the nose piece 300 may be similar in configuration to the nose piece 7 as described above and may serve the same function and fit into the strand cutter 100 in the same manner, such as shown in FIG. 2, for example. Nose piece 300 has a cutting chamber that is internal and has a channel 310 (or strand receiving slot) for the tendon to be received within. The fixed blade 306 may be received and non-rotatably retained within the nose piece 300 within the cutting chamber at the recess 312 that matches the shape of the fixed blade (i.e., the sides 328 of fixed blade 306).

In various embodiments, the nose piece 300 may be used in the configuration using a two-piece assembly, as described, for example, in FIGS. 13-16. The alternate cutting assembly described herein may be used in the same or similar manner as described for FIGS. 13-16 below by replacing the nose piece 210 with nose piece 300.

Referring to FIGS. 21 and 22, the secondary drive gear 302 may be similar in configuration to secondary drive gear 3, and may serve the same function and fit into the strand cutter 100 in the same manner, such as shown in FIG. 2, for example. The secondary drive gear 302 has a recess 314 to mate with the rotating blade assembly 304; that is, it may have a shape to match that of the drive gear engagement 324 of the rotating blade assembly. The secondary drive gear may have a channel (or strand receiving slot) 315.

Referring to FIGS. 23 and 24, the rotating blade assembly 304 may be similar in configuration to rotating blade assembly 5 as described above and may serve the same function and fit into the strand cutter 100 in the same manner (using secondary drive gear 302), such as shown in FIG. 2, for example. Blade mount 316 may be generally cylindrical with a cutting axis C1 (that matches the cutting axis C, described above) and has an outer wall 318 and a cutting strand slot 320 (or strand receiving slot). In various embodiments, the front edge 332 of the cutting strand slot 320 (i.e., the portion on the end with the mounting shoulder and drive gear engagement as described below) may be chamfered and the rear edge 334 may be left sharp (i.e., not machined in the same manner as the front edge).

The internal blade structure of the rotating blade assembly 304 may be the same as that described above with respect to rotating blade assembly 5 in FIGS. 9-12, for example. That is, the description and features of those figures equally applies to the rotating blade assembly 304 when used in place of rotating blade assembly 5.

Rotating blade assembly 304 includes mounting shoulder 322, drive gear engagement 324 mounted to mounting shoulder 322, and blade mount 316 mounted to mounting shoulder 322. Mounting shoulder 322 is configured to rotate within front housing 1 and to support rotating blade assembly 304 within the strand cutter. Drive gear engagement 324 is non-circular and is configured to engage a corresponding recess 314 in secondary drive gear 302, so as to allow the transmission of torque from secondary drive gear 302 to rotating blade assembly 304. The drive gear engagement 324 is of a different shape than drive gear engagement 96 as can be seen (compare FIG. 23 with FIG. 8). The drive gear engagement 96 has a rectangular shape with rounded corners. In contrast, the drive gear engagement 324 has an angular type shape with less rounded corners. In various embodiments, the drive gear engagement 324 may be polygonal in shape. Note that the one side of the shape has the cutting strand slot 320. A hexagonal or hexagon shape may be used in exemplary embodiments. The angular (or polygonal) shape of drive gear engagement 324 may allow for better torque transmission and less slipping of the rotating blade assembly. It should be appreciated that this shape is exemplary. Various embodiments may use other similar shapes and configurations. For example, the drive gear engagement may be structured with different polygonal or angular shapes such as having different numbers of sides such as in the ranges of 4-10 sides, 5-9 sides, or 5-8 sides. It should be appreciated that other shapes may be used. The secondary drive gear 302 recess 314 may be shaped or configured to receive the drive gear engagement 324.

Referring to FIGS. 25 and 26, the fixed blade 306 may be similar in configuration to fixed blade 23 as described above and may serve the same function and fit into the strand cutter 100 in the same manner (with the nose piece 300), such as shown in FIG. 2, for example. The fixed blade 306 may be used in place of the fixed blade 23 in various embodiments.

The fixed blade 306 may therefore be configured to non-rotatably engage the mounting recess 312 inside the nose piece 300 (which may be shaped or configured to receive the fixed blade). The fixed blade 306 has a strand slot 326 (or strand receiving slot). The fixed blade 306 may have sides with a non-rounded shape (that is, having a sharp break between sides 328 and 330, as opposed to the more rounded sides of fixed blade 23). In various embodiments, the sides may be referred to as angular. The edge 336 of the strand slot 326 (on both sides) may be left sharp (i.e., not chamfered). The perimeter edge 338 (on both sides) may be ground (such as after any heat treatment of the fixed blade) to create a chamfered or sloped edge. The internal angle 340 is 129 degrees and the internal angle 342 is 115 degrees 30 minutes. It should be understood that these are exemplary measurements. In various embodiments, the sides and angles of the fixed blade may be structured differently.

The cutting strand slots (which may be referred to as strand receiving slots) 320, 326 (which are U-shaped) of rotating blade assembly 304 and fixed blade 306, respectively, are configured to receive a strand (cable) therein. The “bottom” or terminus of each U-shaped strand slot may be adjacent to cutting axis C1. Fixed blade 306 and rotating blade assembly 304 are configured such that a strand positioned in the respective strand slots will be sheared when rotating blade assembly 304 has rotated 180° about cutting axis C1. When the cutting strand slot 320 of rotating blade assembly 304 is aligned with the strand slot 326 of fixed blade 306, i.e. at 0° of rotation, the tool is in a fully open position.

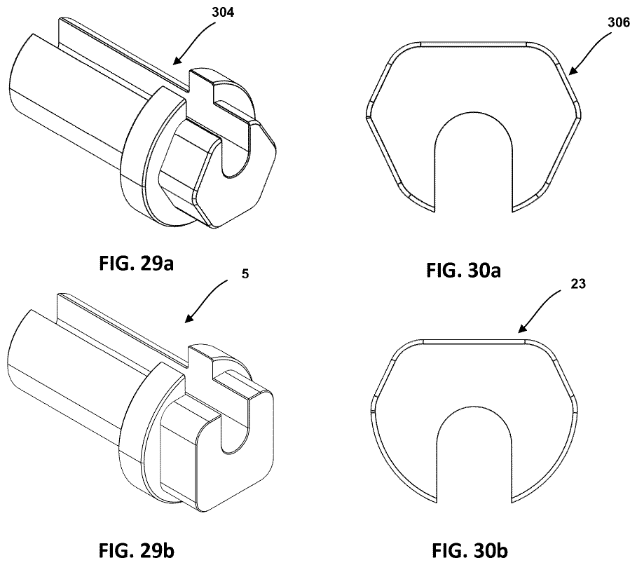

FIGS. 27a and b, 28a and b, 29a and b, and 30a and b provide a comparison between the cutting assembly and the alternate cutting assembly as described above. Specifically, FIGS. 27a and 27b provide a comparison between nose piece 300 and nose piece 7 from a rear view perspective; FIGS. 28a and 28b provide a comparison between secondary drive gear 302 and secondary drive gear 3 from a front view perspective; FIGS. 29a and 29b provide a comparison between rotating blade assembly 304 and rotating blade assembly 5 from perspective views; and FIGS. 30a and 30b provide a comparison between fixed blade 306 and fixed blade 23 from a front view perspective.

In operation, the embodiments described above may be used in the same manner as the other embodiments of the cutting assembly are and the description provided herein is equally applicable when the alternate embodiment reference numbers are substituted into the description as appropriate.

### Clamp Assembly

Referring to FIGS. 2 and 6, the strand cutter 100 may also include clamp assembly 70. Clamp assembly 70 is mechanically coupled to the drive assembly 58. In certain embodiments, clamp assembly 70 may include clamp housing 28 that is enclosed at one end by clamp cover plate 29 and at the other end by clamp mount plate 32. Housed within clamp housing 28 may be left and right clamp arms 53a, 53b, respectively (FIG. 6), pivot rod 74, torsion spring 31, and at least one clamp mounting screw 36. Clamp mounting screw(s) 36 may extend longitudinally through clamp housing 28 and through clamp mount plate 32. In some embodiments, the forward end(s) of clamp mounting screw(s) 36 may engage secondary drive gear 3 to allow clamp assembly 70 to rotate about cutting axis C in conjunction with rotating blade assembly 5.

Left and right clamp arms 53a, 53b each include shoulder 85 and one or more sleeves 78. In the illustrated embodiment, each clamp arm 53a, 53b has three sleeves 78, but the number of sleeves is a matter of design choice. Sleeves 78 are configured so that left and right clamp arms 53a, 53b may be positioned in an operational configuration in which sleeves 78 are coaxial and define a pivot axis. Pivot rod 74 may extend through sleeves 78. Torsion spring 31 may be positioned around pivot rod 74 such that one end of torsion spring 31 bears on each clamp arm 53a, 53b, thereby urging clamp arms 53a, 53b in opposite directions relative to pivot rod 74, resulting in a spring-loaded clamp assembly 70. Sleeves 78 may also be longitudinally spaced such that sleeves 78 on left clamp arm 53a interleave with sleeves 78 on right clamp arm 53b, allowing left and right clamp arms 53a, 53b to be longitudinally aligned.

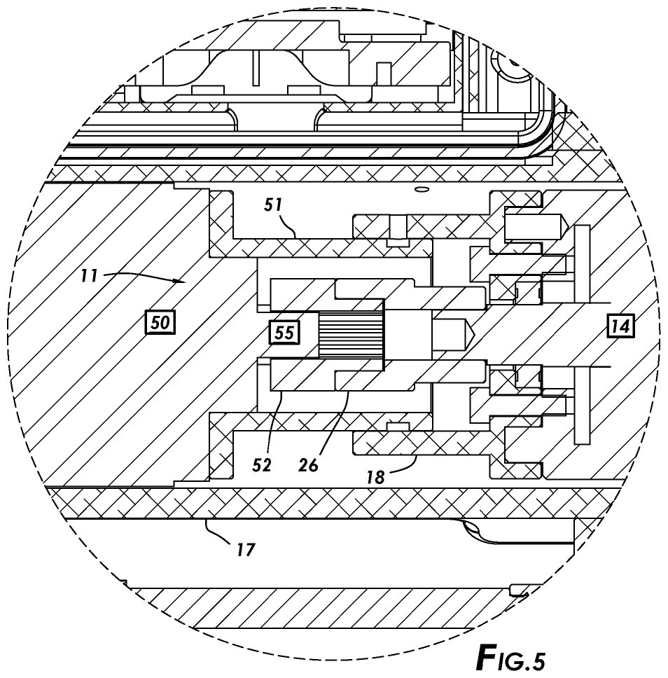

In addition to sleeves 78, left and right clamp arms 53a, 53b each include curved clamping face 82 that includes guide 84, neck portion 86, and strand-receiving groove 88. Each neck portion 86 may be positioned between guide 84 and strand-receiving groove 88. Referring to FIG. 7, when clamp assembly 70 is in an operational configuration, clamping faces 82 are urged toward each other by torsion spring 31. Guides 84 cooperate to define clamp entry 90 and stand-receiving grooves 88 cooperate to define strand channel 92. In some embodiments, neck portions 86 may bear on each other. Clamp entry 90 and strand channel 92 may be parallel with cutting axis C.

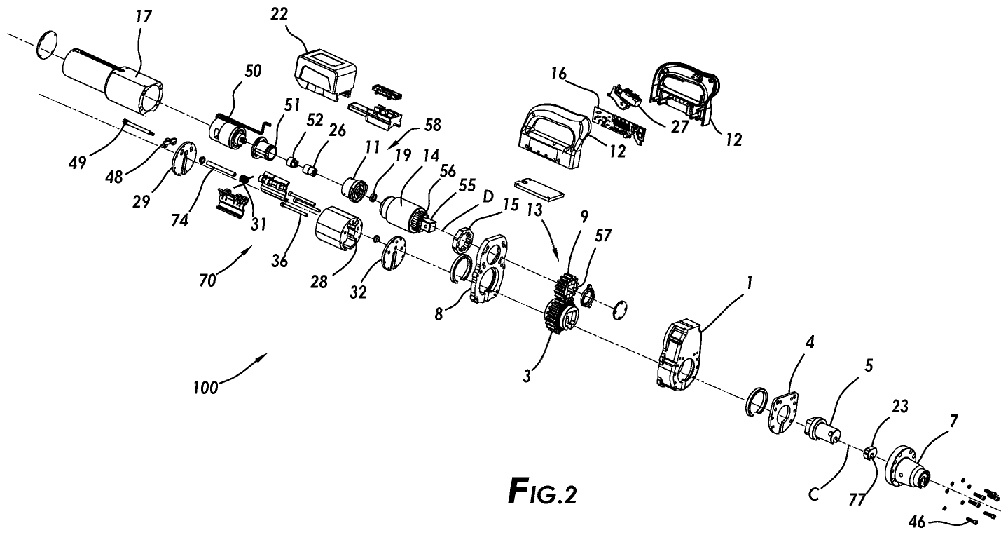

Strand cutter 100 may cut a strand at a predetermined point on the strand without requiring the strand to be threaded into a cutting device. Strand cutter 100 is provided with a throat 103, such as shown in FIG. 3. Throat 103 may include a groove or slot that extends along a bottom surface of the strand cutter 100. Throat 103 provides for a strand to be received into clamp assembly 70 and strand slots 77, 120, laterally, i.e. by moving strand cutter 100 in a direction normal to the strand and normal to cutting axis C, so that cutting axis C moves toward the strand, rather than threading the strand through a closed opening along cutting axis C.

In some embodiments, throat 103 may be formed by providing a strand-receiving slot in each of the components along cutting axis C. Thus, clamp assembly 70, mounting plate 8, secondary drive gear 3, front housing 1, wear plate 4, rotating blade assembly 5, fixed blade 23, and nose piece 7 may each include a strand-receiving slot. For clamp assembly 70, clamp housing 28, clamp cover plate 29, and clamp mount plate 32 each include a strand-receiving slot, so that a strand may enter clamp assembly 70 laterally. Similarly, in mounting plate 8, secondary drive gear 3, front housing 1, wear plate 4, and nose piece 7, the respective strand-receiving slots are configured to receive a strand and to align with the strand slots when the tool is in an open position. For fixed blade 23 and rotating blade assembly 5, the strand-receiving slots are shown as strand slots 77 and 120, i.e. the slots whose relative rotation results in cutting of the strand. The throat-forming strand-receiving slots are aligned and configured such that a strand may be positioned on cutting axis C by placing strand cutter 100 onto a strand laterally.

In some embodiments, as strand cutter 100 is placed on a strand, the strand enters throat 103. As the strand moves into spring-loaded clamp assembly 70, the strand will enter clamp entry 90 and will bear on neck portions 86. Applying to strand cutter 100 an engagement force normal to the strand will cause the strand to push neck portions 86 apart. Application of a sufficient engagement force will overcome the opposing force of torsion spring 31, allowing clamping arms 53a, 53b, to rotate about pivot rod 74 and allow the strand to enter strand channel 92. Once the strand is received in strand channel 92, torsion spring 31 urges clamping arms 53a, 53b, to rotate back to a closed position in which the strand is retained in strand channel 92 by neck portions 86.

In some embodiments, because no separate operation is required in order to fix a strand in strand cutter 100 in a preparation for cutting, an operator's hands can be used for positioning and operating the strand cutter and can remain clear of the strand and the cutting zone.

In some embodiments, a clamp opener 48 may work in conjunction with pin 49 that extends through clamp housing 28 into engagement with clamp arms 53a and/or 53b to enable clamp assembly 70 to be opened manually instead of by applying an opening force via a strand.

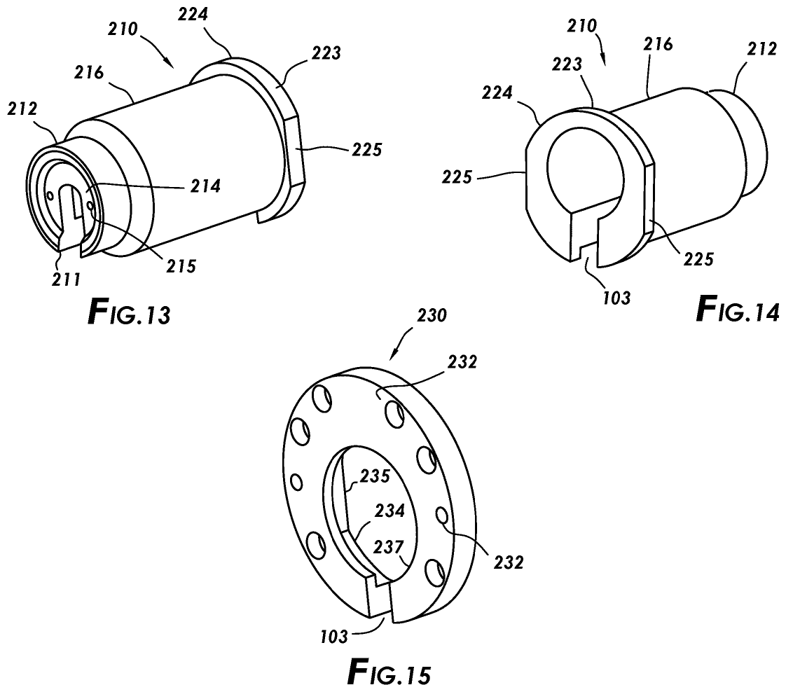

Referring now to FIGS. 13-16, in certain embodiments, nose piece 7, as shown in FIGS. 1 and 2, is replaced with a two-piece nose piece assembly that includes generally cylindrical nose piece 210 and flange plate 230, i.e., the combination of FIGS. 13 and 15. Nose piece 210 may include pocket engagement section 212 coupled or formed integrally with nose piece body 216, which is coupled to or formed integrally with shoulder 224. Pocket engagement section 212 may include forward lip 211 and recessed face 214. Pocket engagement section 212 may also include fixed blade receptacle 218 for receiving fixed blade 23 (FIG. 2). Pocket engagement section 212 may also include one or more extraction holes 215 extending through recessed face 214 and into fixed blade receptacle 218 for facilitating removal of fixed blade 23 from fixed blade receptacle 218. The inner wall of fixed blade receptacle 218 and the outside of fixed blade 23 correspond in shape and may each have a square, hexagonal, or other non-round shape to facilitate the transmission of torque to fixed blade 23 and may prevent rotation of fixed blade 23 within nose piece 210. Nose piece 210 has a longitudinal nose piece axis N.

Nose piece body 216 may be frustoconical or may be generally cylindrical as illustrated and may include an eccentric bore that defines a rotating blade receptacle 219. Rotating blade receptacle 219 may be generally cylindrical with a longitudinal axis R that is parallel to but offset from nose piece axis N. Rotating blade receptacle 219 is configured to receive and support a rotating blade assembly such as rotating blade assembly 5 or rotating blade assembly 105 described below.

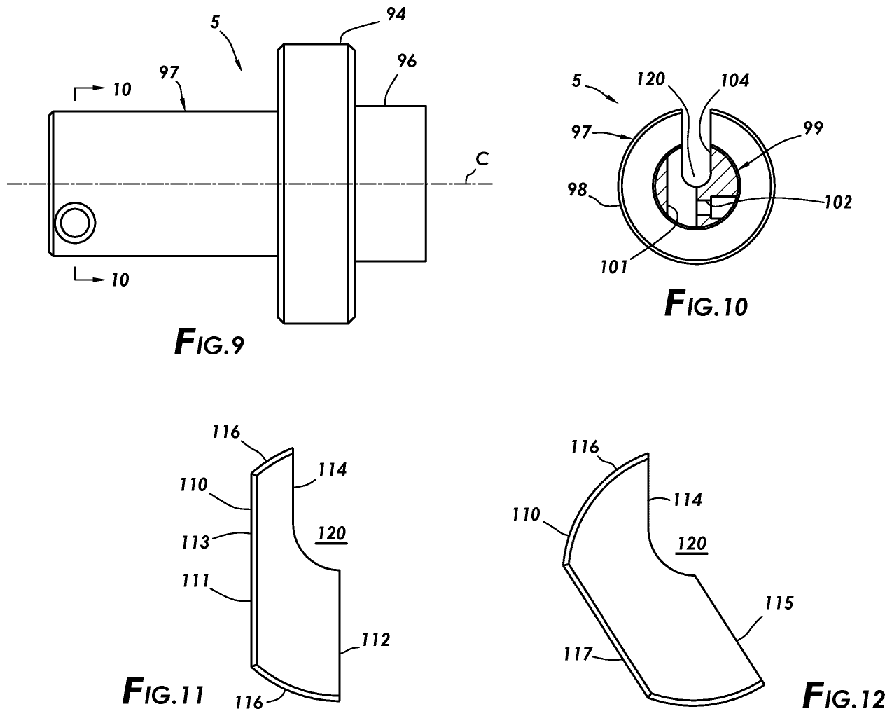

Shoulder 224 of nose piece 210 may have generally circular circumferential face 223. Circumferential face 223 may have a diameter greater than the diameter of nose piece body 216 and may include at least one flat 225. In the embodiment illustrated in FIGS. 13 and 14, circumferential face 223 includes two parallel flats 225; in other embodiments shoulder 224 may include more than two flats 225 or may have a non-circular shape, such as square or hexagonal. Shoulder 224 may be integrally formed with nose piece 210.

Referring to FIG. 15, flange plate 230 may be generally circular and may include retaining face 232 having lip 234 extending longitudinally therefrom. The longitudinal extent of lip 234 may be substantially equal to the thickness of shoulder 224. Retaining face 232 may include eccentric opening 237 that is sized and configured to receive nose piece body 216 therethrough. Eccentric opening 237 may be sized to prevent or restrict the passage of shoulder 224 therethrough, whereby flange plate 230 may be used to retain nose piece 210 in a desired position. The inner surface of lip 234 may include flats 235 configured to correspond to and engage with flats 225 on nose piece 210. Engagement of flats 235 with 225 on nose piece 210 may help prevent rotation of nose piece 210 relative to flange plate 230. The combination of fasteners 46 affixing flange plate 230 to strand cutter 100 and engagement of flats 235 with flats 225 serves to non-rotatably couple nose piece 210 to front housing 1 and to place rotating blade assembly 105 into engagement with drive assembly 58.

Flange plate 230 and nose piece 210 may each include a slot that is configured to align with slots in the other components of strand cutter 100 and form part of throat 103.

Referring now to FIGS. 17 and 18, in certain embodiments, rotating blade assembly 105 may include cutting body 107 coupled to or integrally formed with drive gear engagement 96 and blade mount 97. Rotating blade assembly 105 may be configured to rotate within and relative to rotating blade receptacle 219 in nose piece 210. Drive gear engagement 96 may be non-circular protuberance coupled to or formed integrally with cutting body 107 and engages a corresponding opening in secondary drive gear 3, so as to allow the transmission of torque from secondary drive gear 3 to rotating blade assembly 5. Cutting body 107 may be generally cylindrical. Cutting body 107 may in some embodiments include blade edge 124 or, in other embodiments, replaceable shear blade 110 as described above. Like rotating blade assembly 5, rotating blade assembly 105 may include cutting strand slot 120. Cutting strand slot 120 aligns with throat 103 when the tool is in an open position and ready to receive a strand therein.

To assemble, rotating blade assembly 105 may be placed into rotating blade receptacle 219 in nose piece 210. Nose piece 210 may be assembled into flange plate 230 such that nose piece body 216 extends through eccentric opening 237 and shoulder 224 is received in lip 234 such that flats 225 engage flats 235. The assembled components 230, 210, and 105 can be assembled with the other components of strand cutter 100 by affixing flange plate 230 to front housing 1.

### Operation

To cut a strand with strand cutter 100, strand cutter 100 is placed onto the strand at the desired location along the strand. Throat 103 is aligned with the strand and strand cutter 100 is advanced toward the strand until the strand passes through the neck of clamp assembly 70 and is received in strand channel 92. Provided the components of strand cutter 100 are properly aligned and the tool is in the open configuration, the strand will also be received in strand slots 120 and 77.

Actuation of trigger 27 will cause power to flow from battery 22 to electric motor 50. Electric motor 50 will output torque that is transmitted via gearbox 14 and coaxial output shaft 55 to primary drive gear 9, which transmits the torque to secondary drive gear 3. Secondary drive gear 3 in turn transmits torque to rotating blade assembly 5 (or 105). In response, rotating blade assembly 5, including replaceable shear blade 110, rotates relative to strand cutter 100. Because fixed blade 23 is non-rotatably mounted to the device, rotating blade assembly 5, including replaceable shear blade 110, rotates relative to fixed blade 23, thereby shearing the strand. When rotating blade assembly 5 has rotated 180° relative to fixed blade 23, the strand will be completely cut. The strand cutter 100 can then be removed from the strand and the rotating blade assembly can be returned to the open position, in which cutting strand slot 120 aligns with throat 103.

In the event that any component in nose piece 210, including fixed blade 23, rotating blade assembly 5, rotating blade assembly 105, or nose piece 210 itself, breaks, becomes dull or otherwise needs replacement, flange plate 230 can be decoupled from strand cutter 100 and the necessary component replaced with a new component. Replacement is quick and easy and does not require disassembly of the rest of strand cutter 100.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

What is claimed is:

1. A cutting assembly for a strand cutter, comprising:
a nose piece body configured to couple with a strand cutter device and having a fixed blade receptacle;
a fixed blade having angular sides that is configured to be received in the fixed blade receptacle;
a drive gear having a rotating blade receptacle;
a rotating blade assembly, wherein the rotating blade assembly includes a cutting body, a shoulder, a replaceable shear blade or a cutting edge, and a drive gear engagement portion having an angular shape; and
the rotating blade assembly being configured to be received in the rotating blade receptacle and the drive gear is configured to engage a drive assembly so as to allow transmission of torque from the drive assembly through the drive gear to the rotating blade assembly.

2. The cutting assembly of claim 1, the nose piece body, the fixed blade, the rotating blade assembly, and the drive gear each comprising a strand slot.

3. The cutting assembly of claim 2, wherein the strand slot is U-shaped.

4. The cutting assembly of claim 1, wherein the nose piece body is frustoconical or cylindrical.

5. The cutting assembly of claim 1, wherein the fixed blade receptacle has an inner wall and the fixed blade has an outside and the inner wall of the fixed blade receptacle and the outside of the fixed blade correspond in shape.

6. The cutting assembly of claim 1, wherein the replaceable shear blade is configured to be removed from the rotating blade receptacle.

7. The cutting assembly of claim 1, wherein the replaceable shear blade includes a first drive face, a second drive face, a curved outer surface, and a blade edge.

8. The cutting assembly of claim 7, wherein the second drive face and the curved outer surface have chamfered edges.

9. The cutting assembly of claim 7, wherein the first drive face and the second drive face engage the rotating blade receptacle.

10. The cutting assembly of claim 7, wherein the first drive face and the second drive face are planar and parallel.

11. The cutting assembly of claim 1, wherein the drive gear engagement portion is a polygonal shape.

12. The cutting assembly of claim 11, wherein the polygonal shape is a hexagon.

13. A rotating blade assembly for a strand cutter, comprising:
a rotating shear blade assembly that comprises a drive gear engagement having an angular shape and a strand channel, wherein the drive gear engagement is configured to engage a drive assembly.

14. The rotating blade assembly of claim 13, further comprising:
a rotatable blade mount for the rotating shear blade assembly; and
a shear blade.

15. The rotating blade assembly of claim 14, wherein the drive gear engagement is configured to allow transmission of torque from the drive assembly to the rotatable blade mount, and further wherein the rotatable blade mount comprises a blade receptacle that is configured to receive the shear blade.

16. The rotating blade assembly of claim 14, wherein the shear blade includes a first drive face and a second drive face.

17. The rotating blade assembly of claim 16, wherein the first drive face and second drive face are planar and parallel.

18. The rotating blade assembly of claim 14, wherein the rotatable blade mount further includes a strand slot portion and wherein the shear blade cooperates with the strand slot portion to define a cutting strand slot.

19. The rotating blade assembly of claim 16, wherein the rotatable blade mount comprises:
an inner shaft having an outer circumference;
a fixed blade including a fixed strand slot; and
the first drive face and the second drive face extends between a bottom of the fixed strand slot and the outer circumference of the inner shaft.

20. The rotating blade assembly of claim 13, wherein the angular shape is a polygonal shape.

21. The rotating blade assembly of claim 20, wherein the polygonal shape is a hexagon.

22. A fixed blade assembly for a strand cutter, comprising:
a strand channel; and
a outer surface having an angular shape configured to non-rotabably engage a mounting recess inside of a nose piece assembly.
